(19) United States
(12) Patent Application Publication
(10) Pub. No.: US 2008/0243929 A1
(43) Pub. Date: Oct. 2, 2008

(54) PROGRAM DIAGRAM PREPARING APPARATUS AND METHOD

(75) Inventors: Takahiro Kawamura, Tokyo (JP); Toshiaki Nakamoto, Yokohama-shi (JP); Yumiko Shimogori, Kawasaki-shi (JP); Shinichi Nagano, Yokohama-shi (JP); Masumi Inaba, Yokohama-shi (JP)

Correspondence Address: Charles N.J Ruggiero, Esq.;Ohlandt, Greeley, Ruggiero & Perle, L.L.P., 10th Floor, One Landmark Square, Stamford, CO, 06901-2682, US

(73) Assignee: Kabushiki Kaisha Toshiba

(21) Appl. No.: 12/051,550

(22) Filed: Mar. 19, 2008

(30) Foreign Application Priority Data
Mar. 28, 2007 (JP) 2007-085115

(51) Int. Cl. G06F 17/30

(52) U.S. Cl. 707/104.1; 707/E17.009

(57) ABSTRACT

A program diagram preparing apparatus includes a storage unit configured to store program information items about a plurality of programs, a calculating unit configured to designate one of the programs as a center program and each of the other programs as first related programs, and to calculate first relativities between the center program and each of the first related programs from various aspects, and a diagram preparing unit configured to prepare a diagram that has a center node representing the center program, a first related node representing the first related program corresponding to the first relativity greater than a preset threshold value, and a first link connecting the center node and the first related node and being able to change in at least one of (a) length, (b) thickness and (c) color density in accordance with the first relativity.

### CROSS-REFERENCE TO RELATED APPLICATIONS

This application is based upon and claims the benefit of priority from prior Japanese Patent Application No. 2007-085115, filed Mar. 28, 2007, the entire contents of which are incorporated herein by reference.

### BACKGROUND OF THE INVENTION

1. Field of the Invention

The present invention relates to an apparatus for preparing a network-type program diagram in which programs are linked, one to another, in accordance with the relationship between the programs. The invention also relates to a method of preparing such a program diagram.

2. Description of the Related Art

Hitherto, program diagrams, such as TV program diagrams or radio program diagrams, have been provided in the form of program guides. Each program guide is a matrix chart, in which the broadcasting hours are plotted in rows and the broadcasting stations are plotted in columns. Therefore, the program guide consists of a number of regions. Each region contains printed information about a program, including the title of the program, the leading performers and the outline of the program. A user may read program guides in order to decide which program he or she will watch or listen to. In recent years, program guides have become available in the form of not only printed media, such as newspapers and magazines, but also electronic program guides (EPGs) that are distributed on networks.

As HDD recorders come into use in increasing numbers, more and more users enjoy programs in time-shift manner, not in real-time manner. They would rather record programs first and enjoy them later, than enjoying the programs actually being broadcast. In the time-shift manner, the broadcasting hours are not related with the hours in which the users watch and listen to the recorded programs. Hence, the conventional program guide, in which the broadcasting hours are plotted in rows, is not so significant to users who enjoy programs in time-shift manner. Further, the conventional program guide provides only a limited amount of program information. In other words, it gives the users the program information about a fraction of a great number of programs broadcast through many channels at present. The conventional program guide may not contain the programs that some user would like to enjoy watching or listening to.

In view of this, a system has been proposed, with which any user can retrieve some candidate programs from a huge program guide containing a great number of programs, merely by inputting a keyword interesting to him or her. JP-A 2005-45745 (KOKAI) discloses a method of displaying the information associated with the category of each program contained in an EPG.

The device, which the user operates to input the keywords to select a program that he or she would like to enjoy, may be a remote controller, not a keyboard. Therefore, it would be troublesome for the user to input the keyword. In the method disclosed in JP-A 2005-45745 (KOKAI), the user can indeed refer to the detailed information associated with each program, but cannot obtain candidate programs directly from the detailed information.

### BRIEF SUMMARY OF THE INVENTION

According to an aspect of the invention, there is provided a program diagram preparing apparatus comprising: a storage unit configured to store program information items about a plurality of programs; a calculating unit configured to designate one of the programs as a center program and each of the other programs as first related programs, and to calculate first relativities between the center program and each of the first related programs from various aspects; and a diagram preparing unit configured to prepare a diagram that has a center node representing the center program, a first related node representing the first related program corresponding to the first relativity greater than a preset threshold value, and a first link connecting the center node and the first related node and being able to change in at least one of (a) length, (b) thickness and (c) color density in accordance with the first relativity.

The present invention can provide an apparatus for preparing a program diagram that enables a user to find a desired program quickly.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

FIG. 1 is a block diagram showing a program diagram preparing apparatus according to a first embodiment;

FIG. 2 is a diagram showing a diagram prepared by the program diagram preparing apparatus shown in FIG. 1;

FIG. 3 is a flowchart explaining how the program diagram preparing apparatus of FIG. 1 operates;

FIG. 4 is a block diagram showing a program diagram preparing apparatus according to a second embodiment;

FIG. 5 is a diagram showing a program prepared by the apparatus shown in FIG. 4;

FIG. 6 is a block diagram showing a program diagram preparing apparatus according to a third embodiment; and

FIG. 7 is a block diagram showing a program diagram preparing apparatus according to a fourth embodiment.

### DETAILED DESCRIPTION OF THE INVENTION

Embodiments of the present invention will be described with reference to the accompanying drawings.

### First Embodiment

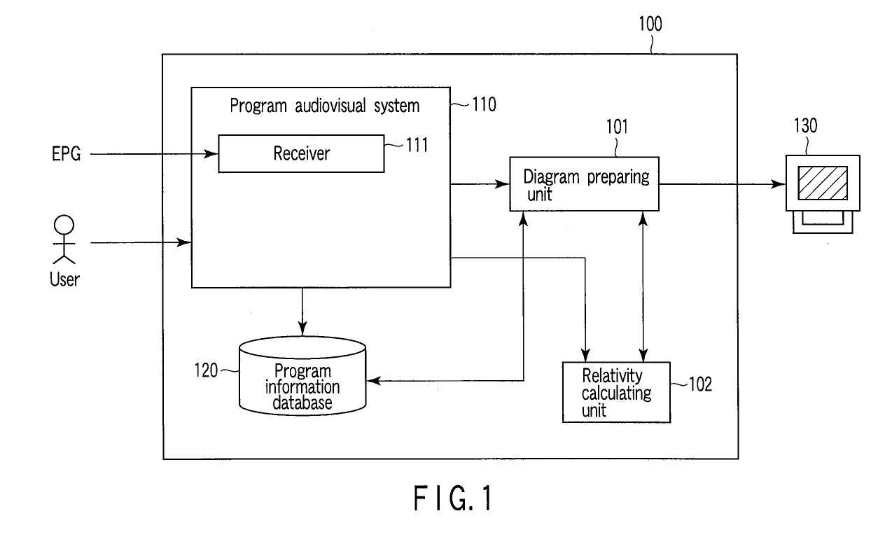

As FIG. 1 shows, a program diagram preparing apparatus 100 according to a first embodiment of this invention has a diagram preparing unit 101, a relativity calculating unit 102, a program audiovisual system 110, and a program information database 120. The program audiovisual system 110 has many functions, one of which is performed by a receiver 111. The diagram preparing unit 101 can prepare a program diagram. A display apparatus 130 may display the program diagram to the user of the program diagram preparing apparatus 100.

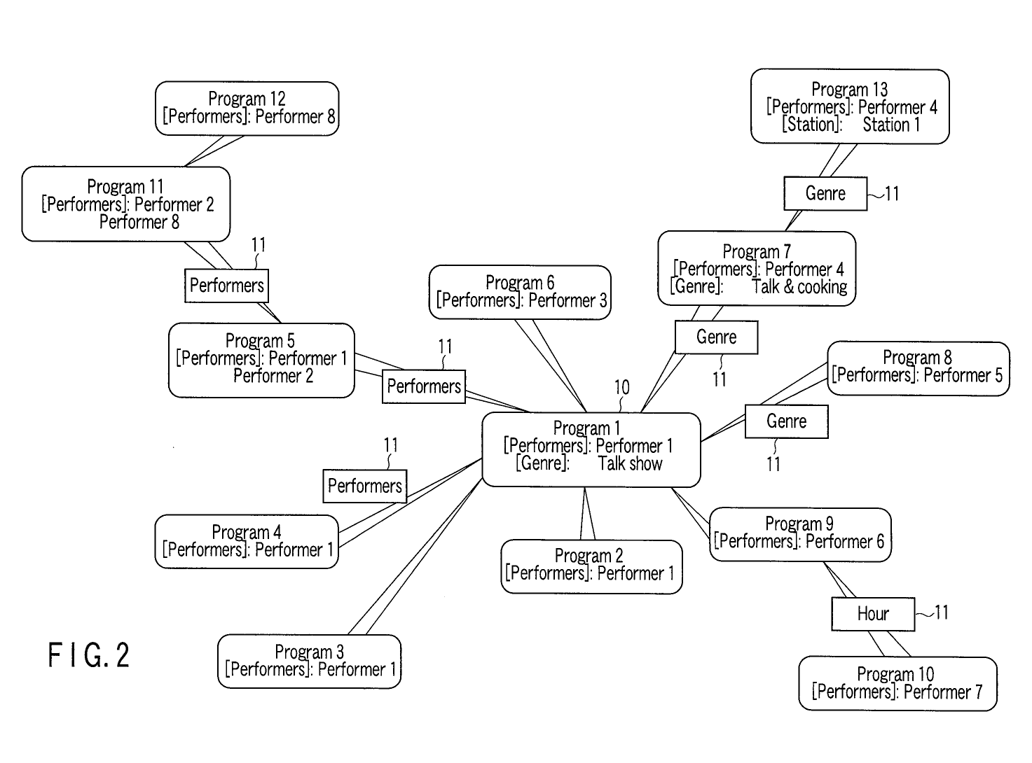

When operated by the user, the program audiovisual system 110 generates a diagram preparation instruction, which is supplied to the diagram preparing unit 101. In accordance with the diagram preparation instruction, the diagram preparing unit 101 prepares a network-type diagram in which various programs are linked, one to another, on the basis of the relationship between the programs. If all programs available are linked, one to another, there will be {n*(n−1)}/2 relationships in all, where n is the number of programs that the user can watch or listen to. In other words, the number of relationships will amount to almost square of n (i.e., number of programs). Hence, it is no feasible to link so many programs, one to another. In the present embodiment, as shown in FIG. 2, the program most interesting to the user is selected as center program 10, and some other programs are linked to the center program 10 in a hierarchical order, thereby formulating a network-type program diagram. In this case, possible relationships will be reduced to n−1 if the center program 10 has one subordinate hierarchical layer. Even if the center program 10 has 2, 3 or more subordinate hierarchical layers, the number of relationships will be far smaller than in the case where all programs are linked, one to another.

More specifically, the program audiovisual system 110 selects a program as center program. The diagram preparing unit 101 reads the program information item of the center program from the program information database 120 and then the program information items of all other programs, from the program information database 120. The program information items thus read are input to the relativity calculating unit 102. The diagram preparing unit 101 processes any program having relativity greater than threshold value TH with respect to the center program, as a program (i.e., a related program of the first layer) that is related to the center program. The diagram preparing unit 101 may find a program (i.e., a related program of the (i+1)th layer, where i is a natural number) related to the related program of the ith layer, on the basis of the relativity between those programs. The diagram preparing unit 101 prepares a diagram illustrating the hierarchical relationship between the center program and the related program of the first layer, and the hierarchical relationship between the related program of the ith layer and the related program of the (i+1)th layer. The data representing this diagram is supplied to the display apparatus 130. The display apparatus 130 displays the diagram to the user. In the diagram the diagram preparing unit 101 has prepared, the center program and any related programs are indicated as nodes, at which the program information about the center program and the program information about the related programs can be referred to. The nodes are such figures as the user can recognize them quickly. For example, the nodes are rectangles or, as shown in FIG. 2, rectangles with rounded corners. These nodes are linked to one another in accordance with the relativity that each has with respect to another. The links, each connecting one node to another, may be lines, arrows or triangles and may differ in length, thickness or color density in accordance with the relativity each node has with respect to another. As will be described later, the relativity each program has with another is a weighed sum of the relativities calculated from various aspects. Therefore, labels 11 or different colors may be added to the links, each showing the aspect that exhibits greatest relativity. Further, each node may be darker in proportion to the distance at which it lies from the node indicating the center program. Further, the diagram may be three-dimensional as a whole, helping the user to recognize any programs that he or she may probably chose.

The relativity calculating unit 102 calculates the relativity between the programs, from those program information items about two programs which have been input from the diagram preparing unit 101. The relativity calculated is a weighted sum of the relativities calculated from various aspects. The weight applied in calculating this weighted sum from various aspects has been supplied from the program audiovisual system 110 and can be changed. The user can change the weight by operating the program audiovisual system 110. The data representing the relativity calculated by the relativity calculating unit 102 is supplied to the diagram preparing unit 101.

The aspects are various items obtained from the information about each program, including the title, genre, leading performers, outline, location, theme, era, broadcast hour, broadcast station, producer, and length of the program. The items obtained from the information may further include those acquired by analyzing the moving picture, such as the brightness of each image (showing whether the image has been shot outdoors or indoors) and the source of each image (showing which type of scene the image has been extracted from, a dynamic one or a static one). The aspects specified here are no more than examples. That is, only some or all of the aspects exemplified above may be used. Any other aspects may be used in addition to the above-exemplified ones. The method of calculating the relativity is not limited here to a specific one. However, a method can be exemplified, nonetheless, in which the items obtained from the program information are used as aspects and the keywords pertaining to the respective aspects are retrieved from the program information and counted, thereby to calculate the relativity for every aspect.

The program audiovisual system 110 has a plurality of functions and generates a diagram and modifies the same in accordance with the inputs made by the user. The program audiovisual system 110 designates the center program, the number of hierarchical layers and the threshold value TH, all for use in the diagram preparing unit 101. Further, the program audiovisual system 110 designates the weight that should be applied to various aspects in the relativity calculating unit 102. The diagram generated by the diagram preparing unit 101 greatly change, depending on the program selected as center program. The program audiovisual system 110 should therefore select, as center program, the very program the user wants to watch or listen to. Hence, the program audiovisual system 110 may designate, as center program, a program the user has recorded, a program the user has recorded and then watched or listened to, a program the user has recorded and not yet erased from the recorder, or a program the user periodically watches or listens to. The program audiovisual system 110 may select two or more programs, not only one, as center programs. If the program audiovisual system 110 has selected two or more center programs, the relativity calculating unit 102 will process the center programs as if they were a single program. Moreover, the user can change the center program, the weight for each aspect, the number of hierarchical layers and the threshold value TH by using the program audiovisual system 110. For example, an interface having a slider may be used in the case where the display apparatus 130 displays the diagram. In this case, the user moves the slider, changing the weight for each aspect, the number of hierarchical layers and the threshold value TH. A new node is thereby selected as new center program. The program audiovisual system 110 supplies the data representing the user's operation on the interface, to the diagram preparing unit 101 and the relativity calculating unit 102. The unit 101 and the unit 102 cooperate, generating a new diagram that reflects the user's operation on the interface. The receiver 111, which is incorporated in the program audiovisual system 110, receives an EPG broadcast or transmitted through a network and stores the program information items contained in the EPG, into the program information database 120.

The program information database 120 holds the program information items contained in the EPG that the receiver 111 has received. How the program information items are handled in the program information database 120 is not specified here. It should be noted, however, that every time the receiver 111 receives an EPG, all program information items may be replaced by those just received. Alternatively, only those of the new program information items, which differ from the program information items already held, may be held in the program information database 120. The program information database 120 also holds the program information items about the programs the user has recorded, about the programs the user has recorded and watched or listened to, about the programs the user has not erased from the recorder and about the programs the user periodically watches or listens to. Flags may be set, each for the programs of each category, so that the programs that more likely meet the user's needs may be distinguished from the other programs. The program information items are transferred from the program information database 120 to the diagram preparing unit 101, in response to a request made by the diagram preparing unit 101.

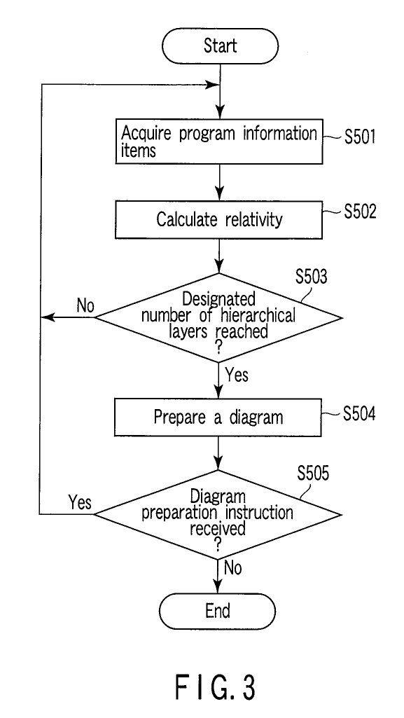

How the program diagram preparing apparatus 100 operates will be explained with reference to the flowchart of FIG. 3.

Upon receiving a diagram preparation instruction from the user, the program audiovisual system 110 transfers this instruction to the diagram preparing unit 101. The diagram preparing unit 101 therefore starts preparing a program diagram. Assume that the program audiovisual system 110 has designated the center program, the number of hierarchical layers (i.e., 3 in this instance), and the threshold value TH. Also assume that weights have already been applied to various aspects in the relativity calculating unit 102.

More precisely, the diagram preparing unit 101 first acquires, from the program information database 120, the program information item about the center program and the program information items about the other programs (Step S501). Next, the diagram preparing unit 101 inputs the program information item about the center program and the program information items about the other programs, to the relativity calculating unit 102, and receives the data representing the relativity calculated by the relativity calculating unit 102 (Step S502). If the relativity calculated in Step S502 is greater than or equal to the threshold value TH, the diagram preparing unit 101 designates the program as a related program of the first hierarchical layer and, hence, as a program that should be illustrated in the program diagram.

Then, it is determined whether the number of hierarchical layers has reached the designated number of hierarchical layers (Step S503). If the number of hierarchical layers has not reached the designated number, the process returns to Step S501, in which the diagram preparing unit 101 acquires the related program relates to the related program at the lowest hierarchical layer in the present diagram. If the number of hierarchical layer has reached the designated number, a diagram meeting the conditions specified by the user can be prepared. In this case, the process goes to Step S504, in which such a diagram is prepared. In this instance, however, the process returns to Step S501 because the designated number of hierarchical layers is 3. In Step S501, the diagram preparing unit 101 acquires, from the program information database 120, the program information item about the center program and the program information items about the other programs. Next, the diagram preparing unit 101 inputs the program information item about the center program and the program information items about the other programs, to the relativity calculating unit 102, and receives the data representing the relativity calculated by the relativity calculating unit 102 (Step S502). If the relativity calculated in Step S502 is greater than or equal to the threshold value TH, the diagram preparing unit 101 designates the program as a related program of the second hierarchical layer. Then, it is determined whether the number of the hierarchical layers has reached the designated number (Step S503). Since the number of hierarchical layers is “2” at present. Therefore, the process returns to Step S501 again. In Step S501, the diagram preparing unit 101 acquires, from the program information database 120, the program information item about the related program of the second hierarchical layer and the program information items about the other programs (excluding the center program and the related program of the first and second hierarchical layer). Then, the diagram preparing unit 101 inputs the information item about the second hierarchical layer and the information items about the other programs, to the relativity calculating unit 102, and receives the data representing the relativity calculated by the relativity calculating unit 102 (Step S502). If the relativity calculated in Step S502 is greater than or equal to the threshold value TH, the diagram preparing unit 101 designates the program as a related program of the third hierarchical layer. Now that the number of hierarchical layers has reached “3” (Step S503), the process goes to Step S504.

In Step S504, the diagram preparing unit 101 draws nodes on the basis of the program information item about the center program and the program information items about the related programs. The unit 101 then draws links on the basis of the relativity of each program with respect to another, whereby a diagram is prepared. A diagram is thereby prepared. Then, the process goes to Step S505. As described above, the diagram drawn is a network-type one in which the nodes representing the center program and some related programs are connected by links that differ in length, thickness or color density in accordance with the relativity each node has with respect to another. Each link is drawn in a specific color indicating the aspect that exhibits greatest relativity, or is attached with a label that shows the aspect that exhibits greatest relativity. The diagram preparing unit 101 may prepare a three-dimensional diagram in which the farther each node is from the center node, the smaller or darker it is presented.

In Step S505, the program diagram preparing apparatus 100 receives a diagram preparation instruction from the user who has seen the diagram prepared in Step S504. As described above, the user can give this instruction to the program audiovisual system 110, changing the diagram preparing parameters, such as the center program, the weight for each aspect, the number of hierarchical layers and threshold value TH, so that a new diagram may be prepared. On receiving the diagram preparation instruction, the program audiovisual system 110 transfers the instruction to the diagram preparing unit 101. The diagram preparing unit 101 and the relativity calculating unit 102 cooperate, generating a new diagram based on the new diagram preparing parameters. The new diagram is shown to the user. (That is, Steps S501 to S504 are repeated.)

As has been explained, the present embodiment prepares a network-type diagram which has a hierarchical structure and in which the center program and some related programs are linked in accordance with the relativity which each program has with respect to another and which has been calculated from various aspects. The present embodiment can therefore show the user some programs in such a way that he or she may quickly recognize them and may therefore easily select one of them. In addition, the user can change the center program, the importance (weight) of each aspect, the number of hierarchical layers and threshold value TH (i.e., relativity evaluating reference) if he or she is dissatisfied with these parameters. Some programs the user may more likely select can therefore be shown to the user.

### Second Embodiment

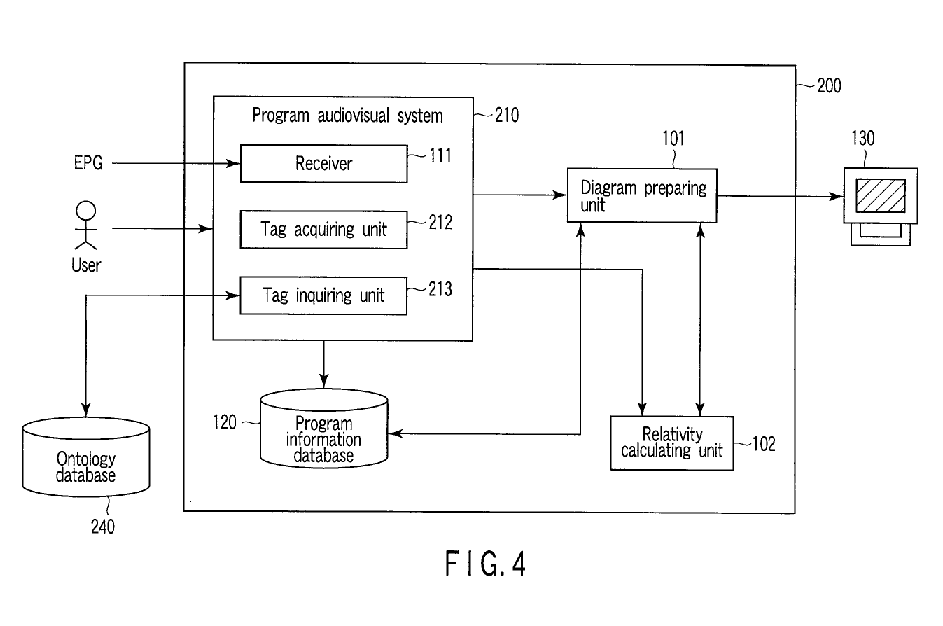

FIG. 4 shows a program diagram preparing apparatus 200 according to a second embodiment of the invention. This program diagram preparing apparatus 200 has a program audiovisual system 210 that is used in place of the program audiovisual system 110 shown in FIG. 1. The components identical to those of the first embodiment (FIG. 1) are designated by the same reference numbers in FIG. 4 and will not be described in detail. The components different from those shown in FIG. 1 will be described in the main.

The program audiovisual system 210 has some functions in addition to the function the program audiovisual system 110 shown in FIG. 1 has. That is, it comprises a tag acquiring unit 212 and a tag inquiring unit 213, as well as a receiver 111.

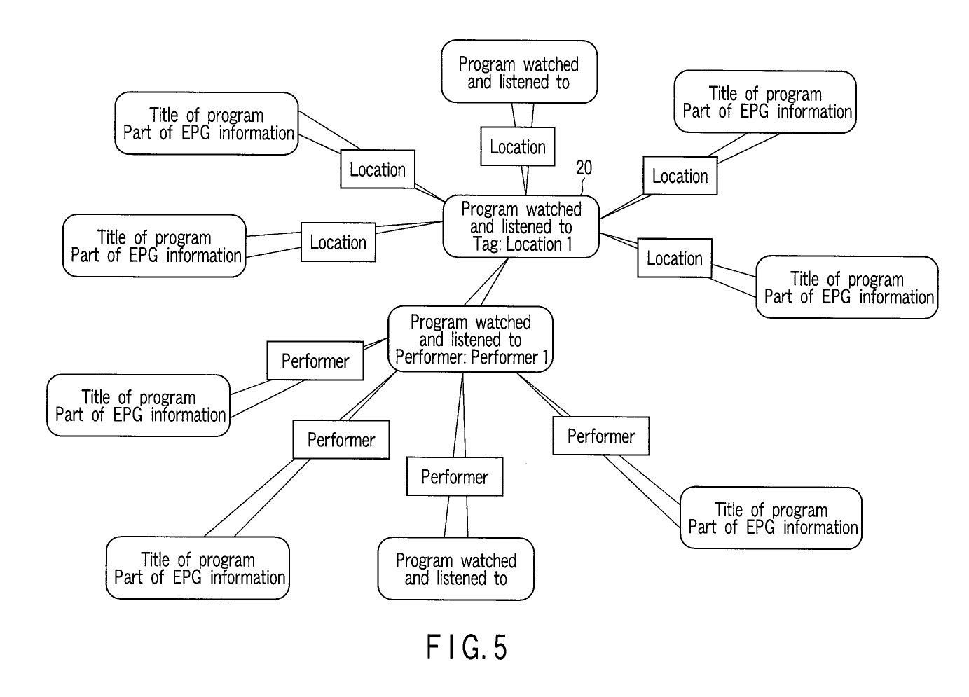

The tag acquiring unit 212 acquires a tag input by the user. The tag is metadata that reinforces program information. The tag is a word that represents, for example, the names of performers, genre, location or trade name related to a program. Assume that a tour guiding program consisting of Parts I and II that have been shot in Okinawa and Hokkaido, respectively. If the program information acquired from the EPG is insufficient, not including the location name of “Hokkaido,” the user may add a tag “Hokkaido” to the information about this tour guiding program. In this case, the data item of “Hokkaido” is used as a part of the program information about the tour guiding program, helping the relativity calculating unit 102 to calculate relativities at higher accuracy. Another example of a tag is the name of a minor performer, which is usually excluded from the EPG, particularly when many performers participate in the program. A tag about such a performer, if input by the user, reinforce the program information. The tag is input when the user operates the virtual keyboard or virtual numeric keypad displayed on the screen of the display apparatus 130 or operates a remote controller, selecting one of the words displayed on the screen. Since any program with a tag is considered very interesting to the user, the program audiovisual system 210 may designate a program of this type as center program 20 as shown in FIG. 5.

The program diagram preparing apparatus 200 is connected to an ontology database 240. The tag inquiring unit 213 asks an ontology database 240 what information the tag acquired has. Even if the tag acquiring unit 212 acquires a tag from the user, the program information cannot be sufficiently reinforced unless the relativity calculating unit 102 utilizes the tag to calculate the relativity of each program with respect to another. This is why the in the present embodiment, the tag inquiring unit 213 asks the ontology database 240 what the tag acquired means. Note that the ontology database 240 is a dictionary that contains a set of concepts pertaining to a specific field of art and defines various relationships between the concepts (e.g., upper, lower, synonymous, anonymous, partial, and entire). A set of words (instances) representing the concepts is also defined in the ontology database 240. Hence, the tag inquiring unit 213 can determine that three tags, “the States,” “USA” and “America,” are the instances of the same concept (aspect), i.e., name of location. The tag inquiring unit 213 can also determine that tag “Unit A” is an upper concept to “Member a1 of Unit A.” For example, the unit 213 determines that “Unit A” is an upper concept to an instance of performer “Member a1” acting in the program. Thus, in this example, “Unit A” and “Member a1” are program information items that are processed in the same manner to calculate the relativity the performer (i.e., aspect) has with respect to the program. Assume that the tag inquiring unit 213 may acquire the concept (aspect) of a tag. This means that the user regards this aspect as important. Therefore, this aspect may be much weighted. In the diagram of FIG. 5, for example, the aspect “location” is greatly weighted for the program attached with tag “Location 1,” and the relativity is then calculated for the program. Similarly, the aspect “performers” is greatly weighted for the program attached with tag “Performer 1,” the relativity is then calculated for this program.

The configuration of the ontology database 240 is not limited to a particular one. The ontology database 240 may be configured to be accessed by another user's program diagram preparing apparatus 200 via a network. An ontology database 240 may be connected to each program diagram preparing apparatus 200 as shown in FIG. 4. In this case, the ontology database 240 may be updated either by the user of each apparatus 200 or via a network.

As has been described, the information about each program is reinforced by using the tag input by the user, in the present embodiment. That is, the weight applied to the center program or in the calculation of relativity is adjusted in accordance with a tag, thereby preparing a network-type diagram which has a hierarchical structure and in which the center program and the related programs are linked in accordance with the relativity which each program has with respect to another and which has been calculated from various aspects. The network-type diagram therefore show the user some programs in such a way that he or she may quickly recognize them and may therefore easily select one of them. Moreover, the user can change the center program, the importance (weight) of each aspect, the number of hierarchical layers and threshold value TH if he or she is dissatisfied with these parameters. Some programs the user may more likely select can therefore be shown to the user.

### Third Embodiment

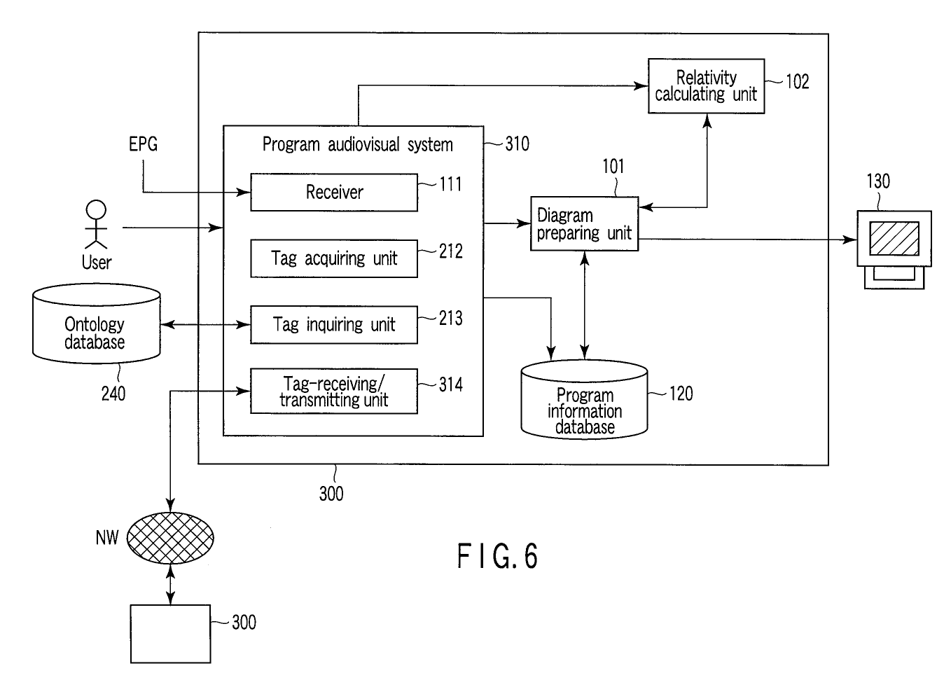

FIG. 6 shows a program diagram preparing apparatus 300 according to a third embodiment of the invention. This program diagram preparing apparatus 300 has a program audiovisual system 310 that is used in place of the program audiovisual system 210 incorporated in the program diagram preparing apparatus 200 shown in FIG. 4. The components identical to those shown in FIG. 4 are designated by the same reference numbers in FIG. 6 and will not be described in detail. The components different from those shown in FIG. 4 will be described in the main.

The program audiovisual system 310 has an additional function, besides the functions identical to those shown in FIG. 4. That is, the system 310 has a tag receiving/transmitting unit 314.

The tag receiving/transmitting unit 314 can receive and transmit tags from and to any other user, through a network NW. If the unit 314 receives, via the network NW, a tag added to a program by any other user, program information can be reinforced in the same manner as is reinforced by a tag the tag acquiring unit 212 has acquired from the user of the program diagram preparing apparatus 300. Further, the tag receiving/transmitting unit 314 can transmit a tag to other users through the network NW. Thus, the tag receiving/transmitting unit 314 can reinforce program information, by sharing the same tag with the other users. Nonetheless, the tag receiving/transmitting unit 314 need not exchange tags with many unspecified users. The user of this program diagram preparing apparatus 300 may impose some access restriction on the other users. In other words, the user may exchange tags with other users who has similar tastes, thus efficiently sharing the tags with the other users.

As has been described, the information about each program is reinforced by exchanging tags between different users, in the present embodiment. More precisely, the weights applied in calculating the relativity are adjusted and the center program is selected in accordance with not only the tag the user has set, but also with the tags the other users have set, thereby preparing a network-type diagram which has a hierarchical structure and in which the center program and the related programs are linked in accordance with the relativity which each program has with respect to another and which has been calculated from various aspects. The network-type diagram therefore shows the user some programs in such a way that he or she may quickly recognize them and may therefore easily select one of them. Moreover, the user can change the center program, the importance (weight) of each aspect, the number of hierarchical layers and threshold value TH if he or she is dissatisfied with these parameters. Some programs the user may more likely select can therefore be shown to the user. Furthermore, the user can set access authenticity for the users of other program diagram preparing apparatuses, in connection with respect to the exchange of tags.

### Fourth Embodiment

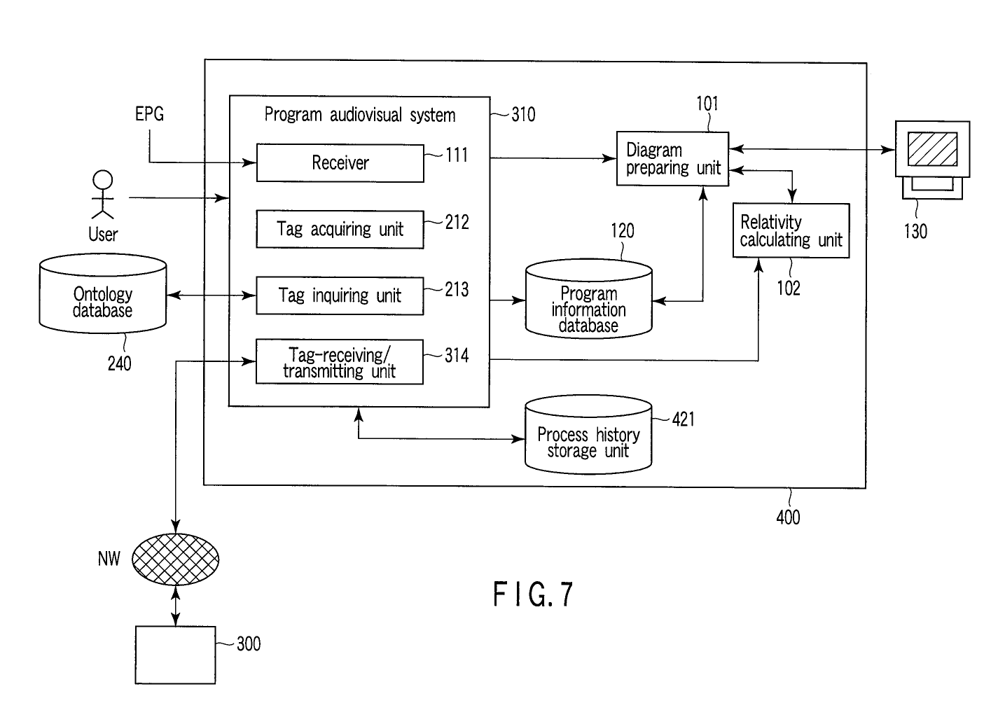

FIG. 7 shows a program diagram preparing apparatus 400 according to a fourth embodiment of the invention. This program diagram preparing apparatus 400 differs from the program diagram preparing apparatus 300 shown in FIG. 6, only in that a process history storage unit 421. The components identical to those shown in FIG. 6 are designated by the same reference numbers in FIG. 7 and will not be described in detail. The components different from those shown in FIG. 6 will be described in the main.

The process history storage unit 421 stores the history of the processes the user has performed on a diagram. The user can perform various processes on the diagram prepared by the diagram preparing unit 101 and displayed by the display apparatus 130. The processes include the changing of the center program, weight for each aspect, the number of hierarchical layers and threshold value TH, the adding of tags, and the tracing of links to refer to a specific node in the diagram.

In the first to third embodiments described above, the program audiovisual system 310 designates the parameters, such as the center program, the weight for each aspect, the number of hierarchical layers and threshold value TH, in order to prepare a program diagram for the first time. The program diagram prepared for the first time is not satisfactory if the parameters designated by the system 310 are quite different from the user's tastes. Therefore, the user will probably change the parameters to have a new diagram prepared.

In the present embodiment, the program audiovisual system 310 utilizes the history of processes stored in the process history storage unit 421, thereby to designate new parameters. More specifically, the weight for each aspect is designated on the basis of the weights the user applied in the past, the aspects pertaining to the tags the user set in the past, the aspects at some links traced in the past, and the like. The center program is designated on the basis of the various center programs the user designated in the past. The number of hierarchical layers is designated on the basis of the numbers the user used or traced in the past. The threshold value TH is designated on the basis of the threshold values TH the user actually used in the past.

As has been described, the parameters for use in preparing a first diagram are designated in the present embodiment, on the basis of the history of the processes the user has performed on a diagram. Hence, the present embodiment can show the user some programs at an early stage in such a way that the user may quickly recognize these programs and may therefore easily select one of them. Moreover, the user can change the center program, the importance (weight) of each aspect, the number of hierarchical layers and threshold value TH if he or she is dissatisfied with these parameters. Some programs the user may more likely select can therefore be shown to the user. Furthermore, the history of processes can be utilized to determine the parameters for use in preparing a next program diagram.

The fourth embodiment is configured by incorporating a process history storage unit 421 in the program diagram preparing apparatus 300 according to the third embodiment. The process history storage unit 421 may be incorporated in the program diagram preparing apparatuses 100 and 200 according to the first and second embodiments, respectively. In this case, too, the same advantages are achieved as in the fourth embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A program diagram preparing apparatus comprising:
a storage unit configured to store program information items about a plurality of programs;
a calculating unit configured to designate one of the programs as a center program and each of the other programs as first related programs, and to calculate first relativities between the center program and each of the first related programs from various aspects; and
a diagram preparing unit configured to prepare a diagram that has a center node representing the center program, a first related node representing the first related program corresponding to the first relativity greater than a preset threshold value, and a first link connecting the center node and the first related node and being able to change in at least one of (a) length, (b) thickness and (c) color density in accordance with the first relativity.

2. The apparatus according to claim 1, wherein the first related node changes in at least one of (a) size and (b) brightness in accordance with the first relativity.

3. The apparatus according to claim 1, wherein the calculating unit is configured to designate programs other than the center program and the first related program represented by the first node as second related programs, and to calculate second relativities between the first related program represented by the first node and each of the second related programs from various aspects, and the diagram further has a second related node representing the second related program corresponding to the second relativity greater than the preset value, a second link connecting the first related node and the second related node and able to change in at least one of (a) length, (b) thickness and (c) color density in accordance with the second relativity.

4. The apparatus according to claim 1, wherein the first link is added with at least one of (a) label and (b) color that accords with an aspect that exhibits greater relativity than any other aspects.

5. The apparatus according to claim 1, wherein the center program has been recorded by a user.

6. The apparatus according to claim 1, wherein the center program has been recorded and watched or listened to by a user.

7. The apparatus according to claim 1, further comprising a reinforcing data acquiring unit configured to acquire reinforcing data that reinforces the program information items.

8. The apparatus according to claim 7, further comprising a receiving/transmitting unit configured to receive and transmit the reinforcing data from and to other users.

9. The apparatus according to claim 7, wherein the center program is added with the reinforcing data.

10. The apparatus according to claim 1, wherein the calculating unit is configured to calculate the first relativity by applying weights to relativities for various aspects and then adding the relativities thus weighted.

11. The apparatus according to claim 10, wherein the calculating unit is configured to apply a largest weight to the relativity for the aspect to be reinforced with the reinforcing data, to calculate the first relativity.

12. The apparatus according to claim 10, which further comprises a process history storage unit configured to store a history of the processes the user has performed on the diagram, and in which at least one of the weight, the threshold value and the center program is determined based on the history stored in the process history storage unit.

13. A program diagram preparing method comprising:
storaging program information items about a plurality of programs;
designating one of the programs as a center program and each of the other programs as first related programs, and calculating first relativities between the center program and each of the first related programs from various aspects; and
preparing a diagram that has a center node representing the center program, a first related node representing the first related program corresponding to the first relativity greater than a preset threshold value, and a first link connecting the center node and the first related node and being able to change in at least one of (a) length, (b) thickness and (c) color density in accordance with the first relativity.

14. A computer readable storage medium storing instructions of a computer program which when executed by a computer results in performance of steps comprising:
storaging program information items about a plurality of programs;
designating one of the programs as a center program and each of the other programs as first related programs, and calculating first relativities between the center program and each of the first related programs from various aspects; and
preparing a diagram that has a center node representing the center program, a first related node representing the first related program corresponding to the first relativity greater than a preset threshold value, and a first link connecting the center node and the first related node and being able to change in at least one of (a) length, (b) thickness and (c) color density in accordance with the first relativity.

15. A computer system comprising:
means for storaging program information items about a plurality of programs;
means for designating one of the programs as a center program and each of the other programs as first related programs, and calculating first relativities between the center program and each of the first related programs from various aspects; and
means for preparing a diagram that has a center node representing the center program, a first related node representing the first related program corresponding to the first relativity greater than a preset threshold value, and a first link connecting the center node and the first related node and being able to change in at least one of (a) length, (b) thickness and (c) color density in accordance with the first relativity.
